(19) United States
(12) Patent Application Publication
(10) Pub. No.: US 2016/0378920 A1
(43) Pub. Date: Dec. 29, 2016

(54) EVENT BASED SYSTEM AND METHOD FOR MANAGING CLINICAL TRIAL DATA

(71) Applicant: INC Research, LLC, Raleigh, NC (US)

(72) Inventors: Nate Thompson, Raleigh, NC (US); Jonathan Shough, Raleigh, NC (US); Sean Parris, Raleigh, NC (US); John Whitaker, Raleigh, NC (US); Tuananh Nguyen, Cary, NC (US); Nataraj Prakash, Moorpark, CA (US); John Randal Jones, Durham, NC (US); David Rubenstein, Raleigh, NC (US)

(21) Appl. No.: 15/170,601

(22) Filed: Jun. 1, 2016

Related U.S. Application Data
(60) Provisional application No. 62/169,100, filed on Jun. 1, 2015.

(51) Int. Cl. G06F 19/00; G06F 17/30

(52) U.S. Cl. CPC G06F 19/322; G06F 17/30634; G06F 19/363; G06F 3/0484

(57) ABSTRACT

A system and method for integrating clinical trial data housed in disparate systems. The integration system listens for a clinical trial event broadcasted by any one of the disparate systems. The clinical trial events are the same or similarly defined among the disparate systems. The integration system receives notice of a clinical trial event from one of the disparate systems and then sends a query to the disparate systems requesting metadata corresponding with the clinical trial event. The metadata is comprised of attributes of the clinical trial event and the values of such metadata may differ among the disparate systems. The responsive metadata is stored in an unstructured format and can be displayed in substantially real-time via a graphical user interface.

### CROSS-REFERENCE TO RELATED APPLICATIONS

The present application hereby claims priority under 35 U.S.C. §119(e) to U.S. Provisional Patent Application Number 62/169,100 filed Jun. 1, 2015 which is incorporated herein by reference in its entirety.

### TECHNOLOGICAL FIELD

The present invention is directed towards a system and method for managing clinical trial data in real-time by capturing and storing event-based data from disparate sources.

### BACKGROUND

When clinical research organizations (CROs) manage clinical trials, the CROs collect, store, track, and manage a plethora of data for each of the trials. Because the data comes from many disparate systems, there are some inherent difficulties in collection and rapid updating of the data. However, CROs need to provide timely operational and clinical visibility to their employees, customers, and partners (referred to herein as internal and external customers). The challenge is that such CROs are often driven by their customers to use management systems that align with the customer's system. Thus, prior art systems that provide operational and clinical visibility are typically bound to use of a particular vendor's solution, which makes it difficult, and in some cases impossible, to capture and display data in real time that is collected from the CROs other customers who are using differing systems and platforms. Such systems and platforms may have differing characteristics such as data formatting, structure of data, outward communication protocol, interface protocol, language, infrastructure, and underlying application software. Thus, there is a need in the art for a system and method that provides such operational and clinical visibility for clinical trials based in real-time, even when the data flows from disparate data recordal systems or platforms.

### BRIEF SUMMARY

A system and method for integrating clinical trial data housed in disparate systems including listening for a clinical trial event broadcasted by any one of the disparate systems, receiving notice of a clinical trial event that is broadcasted from at least one of the disparate systems, sending a query to the disparate systems requesting metadata corresponding with the clinical trial event, listening for responses to the query from the disparate systems, receiving from the disparate systems the metadata corresponding with the clinical trial event, and storing the metadata in an unstructured format, and displaying via a graphical user interface in substantially real-time the clinical trial event and the associated metadata as received from the disparate systems. The clinical trial event is a distinct event that is similarly defined in the disparate systems. The metadata may include data about the corresponding clinical trial event, such as attributes thereof. The metadata for the clinical event in at least one disparate system may differ in some respects from the metadata for the same clinical event in at least one additional disparate system.

Examples of the clinical trial events are site activation, invoice paid, projected grants, actual grants received, actual patients enrolled, patient forecast high, patient forecast low, patient forecast ceiling, number of study deaths, number of terminated sites, number of non-enrolled sites, projected study commencement date, actual study commencement date, number of adverse events leading to discontinuation of a study, number of protocol deviations, number of assigned full time equivalents (FTE), and amount budgeted for FTEs. The disparate systems use platforms for managing and structuring data such as batch, publish, and application program interface. The disparate systems may also have characteristics that differ such as data formatting, structure of data, outward communication protocol, interface protocol, language, infrastructure, and underlying application software.

An alert is generated when one of the disparate systems does not respond to the query or when a value or parameter of the metadata received from one of the disparate systems is outside of a predetermined range. User access to the metadata can be verified by the system based on predefined user access rules. A schedule can be predefined for when the query is sent to the disparate systems.

In yet a further implementation of the present disclosure, an apparatus for implementing the above-described system and method for integrating clinical trial data housed in disparate data recordal systems or platforms is provided. The computing apparatus includes a data processor and a memory that receives and compiles data from disparate data recordal systems, the system computing the steps of listening for a clinical trial event broadcasted by any one of the disparate system, receiving a signal indicative of a clinical trial event or notificationthat is broadcasted from at least one of the disparate data recordal system, sending a query to the disparate data recordal systems requesting metadata corresponding with the clinical trial event, listening for responses to the query from the disparate systems, receiving from the disparate systems the metadata corresponding with the clinical trial event, storing the metadata in the memory in an unstructured format, and making available for display, via a graphical user interface, in substantially real-time the clinical trial event and the associated metadata as received from the disparate data recordal systems.

### BRIEF DESCRIPTION OF THE DRAWINGS

Reference will now be made to the accompanying drawings, which are not necessarily drawn to scale, wherein:

FIG. 1 is block diagram of an embodiment of the integration system of the present invention.

FIG. 2 is a flowchart of an embodiment of the integration system of the present invention.

FIG. 3 is a screen shot of an embodiment of the integration system of the present invention.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embedded in many different forms and should not be construed as limited to the implementations set forth herein; rather, these example implementations are provided so that this disclosure will be thorough and complete, and will fully convey the scope of disclosure to those skilled in the art. For example, unless otherwise indicated, reference to something as being first, second or the like should not be construed to imply a particular order. Like reference numerals refer to like elements throughout.

Example implementations of the present invention include a system and method for capturing, storing, and displaying clinical trial data in substantially real-time across an array of disparate clinical trial data systems. This integration system allows for consistent, normalized information even in the event that the data flows from multiple, disparate data recordal systems. All information is presented through a singular, role-based user interface for use with internal and external customers.

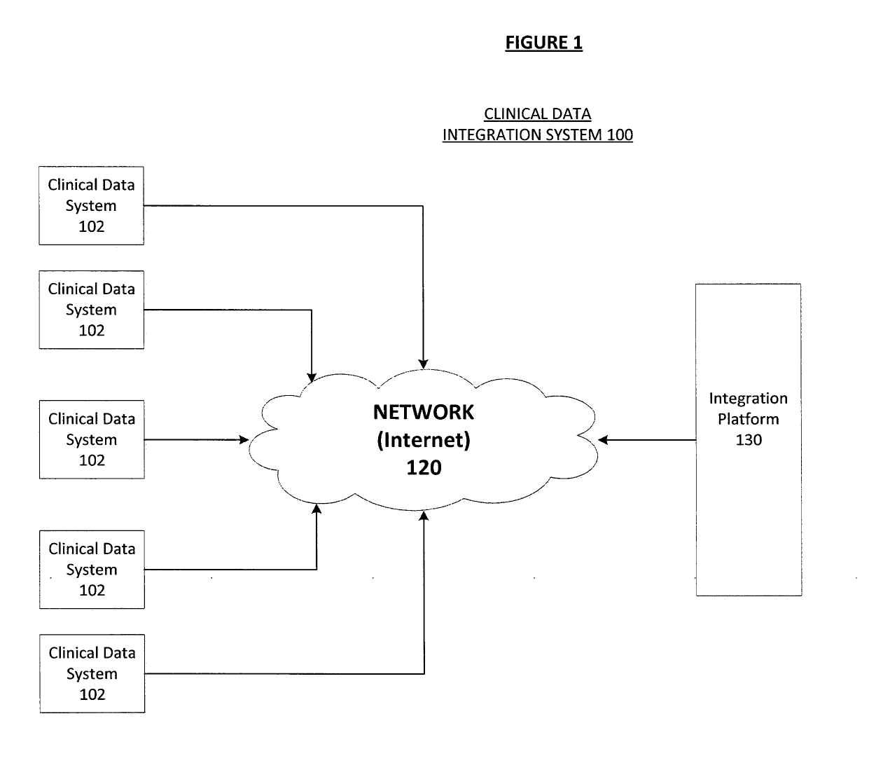

With reference now to the figures, FIG. 1 is a block diagram depicting an example of a clinical data integration system 100 in accordance with an embodiment of the present invention. The system 100 includes multiple clinical data recordal systems 102 that may all be using different types of computing platforms and communications protocols such as batch, publish, or subscribe application program interface (API) methodology. The varying computing platforms may include executable computer applications therefore. The clinical trial data systems 102 may each comprise digital computing devices having input and display means, one or more processors, memory, and a communication or network interface for connecting to a network 120, such as the Internet.

The system 100 further includes an integration platform 130 that resides on at least one digital computing device having input and display means, one or more processors, memory, and a communication or network interface for connecting to a network 120. Unlike prior art clinical trial visualization systems that integrate data points from particular, predefined clinical trial data systems 102, the integration platform 130 according to an implementation of the present disclosure is specially configured to remove the dependency on using a finite set of clinical trial data systems 102. In order to accomplish this, the integration platform 130 of the present invention is based on industry-standard business and/or clinical events that are the same or substantially similar in every system that houses information pertaining to clinical trials.

By way of example, clinical trial events are events, occurrences, or aspects of a clinical trial that typically occur during the process of performing clinical trial research, such as: site activation, invoice paid, projected grants, actual grants received, actual patients enrolled, patient forecast high, patient forecast low, patient forecast ceiling, number of study deaths, number of terminated sites, number of non-enrolled sites, projected study commencement date, actual study commencement date, number of adverse events leading to discontinuation of a study, number of protocol deviations, number of assigned full time equivalents (FTE), and amount budgeted for FTEs, etc. In the example event of “site activation,” example attributes or metadata that may be associated with that event include: the study number, the name of the leading physician, the contact information for such physician, the location of the site, the type of study, etc. In the example event of “actual patients enrolled,” example attributes may include: the patient identifiers, where the patient resides, the type of study the patient is enrolled in, and the date and time of enrollment, etc.

Because the integration platform 130 is built on clinical events, rather than specific data associated with them, the integration platform 130 is able to listen to (in a listening mode) and query (by way of an output signal) the many clinical data systems 102 using disparate platforms and applications to determine when such events occur at the various trial sites. The integration platform 130 then requests and extracts the specific metadata (attributes) associated with the event from one or more of the various clinical data systems 102, as explained in more detail below.

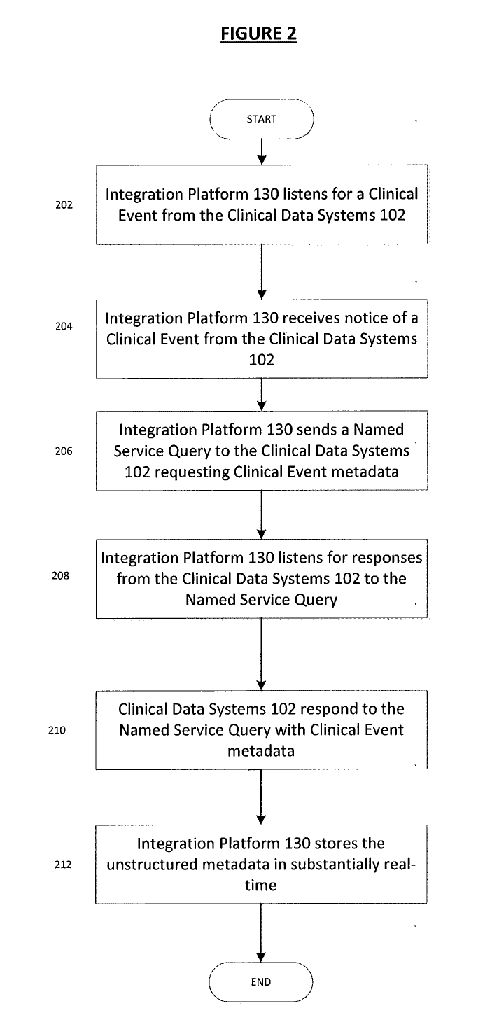

Referring now to the flowchart shown in FIG. 2, when the system 100 is in operation, the integration platform 130 listens to the disparate clinical data systems 102 for when any of such systems 102 broadcasts a clinical event (step 202), such as a particular clinical data system 102 broadcasting the event of a site activation for particular study, by way of a signal transmitted over the communications network 120. When the integration platform 130 is notified of an event (step 204), the integration platform 130 sends queries to the other clinical data systems 102 requesting metadata and files associated with such event, which is referred to as named query service (step 206). A notification services module then facilitates how the integration platform 130 listens for responses/output signals from the clinical data systems 102 when they have metadata about that particular event (step 208). The clinical data systems 102 may respond with metadata referenced above such as the study number, the name of the leading physician, the contact information for such physician, the location of the site, the type of study, etc. (step 210). Such metadata may come from one or more of the clinical data systems 102 and each of such systems 102 may be running a different platform for managing and structuring such data. Because the integration platform 130 of the present invention does not require any translation of the metadata on the front end, the integration platform 130 is able to collect, integrate, and store the metadata, unstructured, in substantially real-time (step 212). The metadata, as collected by the integration platform 130, is unstructured in that it is substantially devoid of a predefined format and is not organized according to a single or predefined format, model.

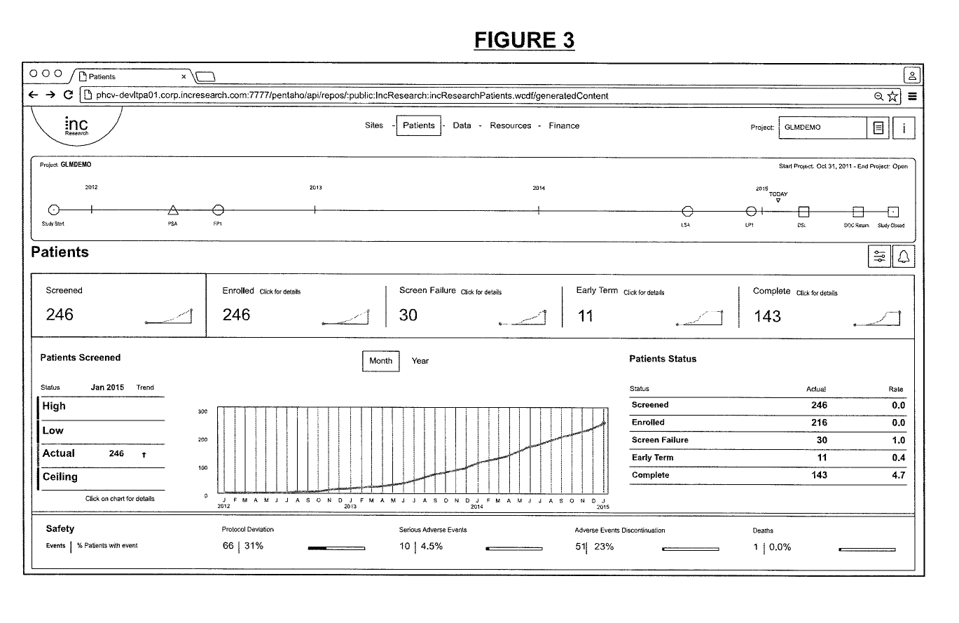

The integration platform 130 may include numerous modules for facilitating the collection of metadata as described above. For example, a data transformation module may be used to transform dated metadata from European format to US format, and vice versa (e.g., Oct. 6, 2015 to Jun. 10, 2015 to Jun. 10, 2015). An audit and error logging module may be configured to detect when there is an error in the data collection process, such as when a particular clinical data system 102 is unresponsive to a named service query, possibly indicating that such system 102 was offline or otherwise unavailable. In this case, the audit and error logging module may generate an alert signal and/or flag the response (or lack thereof) as needing further review and/or follow-up. An alert notification and processing module may be configured to generate an alert signal when the integration platform 130 expects a particular metadata value or parameter from a clinical data system 102 but the metadata is not received or not within the expected range. An authentication module is configured to verify the access to the metadata in the disparate clinical data systems 102, which facilitates the CROs management of role-based data viewing. For example, certain of the CRO's internal and external customers may be set up to have access to only a limited portion of data. A services configuration module functions as a configuration engine that facilitates communication between the clinical data systems 102 and the integration platform 130 by identifying and sharing appropriate access information such as URLs, usernames, and passwords. Modules referred to as enterprise file event service and event data capture facilitate the collection of all the files and metadata therein that is responsive to the named query service. An enterprise scheduling services module is provided to facilitate automated scheduling of queries and other jobs. A dashboard module is provided for generating graphical visualizations depicting the health and status of the clinical trials. For example, the dashboard module may highlight events as compared to the trial's predefined targets and plans. The dashboard module also provides an ability to see from which clinical data system 102 each piece of data has been sourced. In the example screen shot shown in FIG. 3, the dashboard module displays aggregate site information for a particular clinical trial, including information such as the number of sites activated and the number of patients enrolled. The exemplary screenshot also depicts information regarding the status of sites relative to the clinical trial process, e.g. selection, funding, contract award, and activation.

In summary, the system 100 of the present invention will benefit any CRO by giving its internal and external customers real-time visibility into the health and operational efficiencies of any study the CRO is conducting. The aggregated and unstructured data collected by using the system 100 will enable the CRO to not only have a real-time snap shot of its clinical studies, but also facilitate use of the aggregate data for further research purposes. Because the integration platform 130 is configured to capture industry standard events encountered in any clinical trial process, the integration platform 130 can collect such event data in real time without regard for the type of application or platform of the clinical data system 102 from which the data is coming. Thus, the integration platform 130 can integrate with any system or application.

While certain embodiments of the invention have been described using specific terms, such description is for present illustrative purposes only, and it is to be understood that changes and variations to such embodiments, including but not limited to the substitution of equivalent features or parts, and the reversal of various features thereof, may be practiced by those of ordinary skill in the art without departing from the spirit or scope of the present disclosure.

What is claimed is:

1. A method for integrating clinical trial data housed in disparate systems comprising:
listening for a clinical trial event broadcasted by any one of the disparate systems;
receiving notice of a clinical trial event that is broadcasted from at least one of the disparate systems;
sending a query to the disparate systems requesting metadata corresponding with the clinical trial event;
listening for responses to the query from the disparate systems;
receiving from the disparate systems the metadata corresponding with the clinical trial event;
storing the metadata in an unstructured format; and
displaying via a graphical user interface in substantially real-time the clinical trial event and the associated metadata as received from the disparate systems;
wherein a clinical trial event is a distinct event or occurrence that is similarly defined in the disparate systems;
wherein the metadata comprises attributes of the corresponding clinical trial event; and
wherein the metadata for the clinical event in the at least one disparate system differs in some respects from the metadata for the same clinical event in at least one additional disparate system.

2. The method of claim 1 wherein the clinical trial event is selected from the group consisting of site activation, invoice paid, projected grants, actual grants received, actual patients enrolled, patient forecast high, patient forecast low, patient forecast ceiling, number of study deaths, number of terminated sites, number of non-enrolled sites, projected study commencement date, actual study commencement date, number of adverse events leading to discontinuation of a study, number of protocol deviations, number of assigned full time equivalents (FTE), and amount budgeted for FTEs.

3. The method of claim 1 wherein the disparate systems use platforms for managing and structuring data selected from the group consisting of batch, publish, and application program interface.

4. The method of claim 1 wherein the disparate systems comprise differing characteristics selected from the group consisting of data formatting, structure of data, outward communication protocol, interface protocol, language, infrastructure, and underlying application software.

5. The method of claim 1 wherein the unstructured format is devoid of a predefined format or structure for organizing the metadata.

6. The method of claim 1 further comprising the step of generating an alert signal when one of the disparate systems does not respond to the query.

7. The method of claim 1 further comprising the step of generating an alert signal when a value or parameter of the metadata received from one of the disparate systems is outside of a predetermined range.

8. The method of claim 1 further comprising the step of verifying user access to the metadata based on predefined user access rules.

9. The method of claim 1 further comprising the step of establishing a predefined schedule for when the query is sent to the disparate systems.

10. A system for integrating clinical trial data housed in disparate systems comprising:
a listening module that listens for and receives notice of a clinical trial event that is broadcasted by any one of a plurality of disparate systems that similarly define a clinical trial event;
a query module that sends a query to the disparate systems requesting metadata corresponding with the clinical trial event;
a receiving module that receives from the disparate systems the metadata corresponding with the clinical trial event;
a memory for storing the metadata in an unstructured format; and
a graphical user interface that displays in substantially real-time the clinical trial event and the associated metadata received from the disparate systems;
wherein the metadata comprises attributes of the corresponding clinical trial event; and
wherein the metadata for a clinical event in the at least one disparate system differs in some respects from the metadata for the same clinical event in at least one additional disparate system.

11. The system of claim 10 wherein the clinical trial event is selected from the group consisting of site activation, invoice paid, projected grants, actual grants received, actual patients enrolled, patient forecast high, patient forecast low, patient forecast ceiling, number of study deaths, number of terminated sites, number of non-enrolled sites, projected study commencement date, actual study commencement date, number of adverse events leading to discontinuation of a study, number of protocol deviations, number of assigned full time equivalents (FTE), and amount budgeted for FTEs.

12. The system of claim 10 wherein the disparate systems use platforms for managing and structuring data selected from the group consisting of batch, publish, and application program interface.

13. The system of claim 10 wherein the disparate systems comprise differing characteristics selected from the group consisting of data formatting, structure of data, outward communication protocol, interface protocol, language, infrastructure, and underlying application software.

14. The system of claim 10 further comprising an alert module that generates an alert when one of the disparate systems does not respond to the query.

15. The system of claim 10 further comprising an alert module that generates an alert when a value or parameter of the metadata received from one of the disparate systems is outside of a predetermined range.

16. The system of claim 10 wherein the unstructured format is devoid of a predefined format or structure for organizing the metadata.

17. The system of claim 10 further comprising a verification module that verifies user access to the metadata based on predefined user access rules.

18. The system of claim 10 further comprising a scheduler module for facilitating establishment of a predefined schedule for when the query is sent to the disparate system.

19. A computing apparatus comprising a processor and a memory that receives and compiles data from disparate data recordal systems, said computing apparatus computing the steps of:
listening for a clinical trial event broadcasted by any one of the disparate system;
receiving a signal indicative of a clinical trial event or notificationthat is broadcasted from at least one of the disparate data recordal system;
sending a query to the disparate data recordal systems requesting metadata corresponding with the clinical trial event;
listening for responses to the query from the disparate systems;
receiving from the disparate systems the metadata corresponding with the clinical trial event;
storing the metadata in the memory in an unstructured format; and
making available for display, via a graphical user interface, in substantially real-time the clinical trial event and the associated metadata as received from the disparate data recordal systems.
